(19) United States
(12) Patent Application Publication
(10) Pub. No.: US 2005/0046806 A1
(43) Pub. Date: Mar. 3, 2005

(54) Illumination system for projector and illumination method thereof

(76) Inventor: Sean Chang, Taoyuan County (TW)

Correspondence Address: LAW OFFICES OF DAVID PAI, 1001 FOURTH AVENUE, SUITE 3200, SEATTLE, WA, 98154, US

(21) Appl. No.: 10/845,945

(22) Filed: May 14, 2004

(30) Foreign Application Priority Data
Aug. 26, 2003 (TW) 92123486

(51) Int. Cl. G03B 21/28

(52) U.S. Cl. 353/81

(57) ABSTRACT

An illumination system for a projector includes a light guide and a light path switching device having a light-receiving section, wherein the light guide is disposed in the light path between the light source and the light path switching device. An end surface of the light guide has a parallelogrammic shape with its two adjacent interior angles different from each other such that a projection pattern formed by the light beams striking the light path switching device at an off-axis angle and the light-receiving section have substantially the same shape and substantially coincide with each other.

### BACKGROUND OF THE INVENTION

(a) Field of the Invention

The invention relates to an illumination system for a projector and, more particularly, to an illumination system capable of effectively enhancing the illumination efficiency.

(b) Description of the Related Art

Nowadays, most existing optical projecting displays utilize an illumination system that incorporates a light path switching device consisting of a plurality of relatively small elements, each element being used to switch light path individually. After being modulated by the switching elements, the light beams emitting from a light source project on a projection surface through a projection lens.

As an example of a light path switching device, Digital Micromirror Device (DMD) manufactured by Texas Instruments (TI) consists of thousands of micromirrors. The DMD panel's micromirrors are mounted on tiny hinges that enable them to tilt either toward the light source (ON state) or away from it (OFF state), thus creating a light or dark pixel on the projection surface.

FIG. 1 is a schematic view of a conventional projection system 100 including a light path switching device 102, where the light path for the light traveling under the ON state is shown.

As shown in FIG. 1, light beams I emitting from a light source (not shown) are reflected by the micromirrors 102a of the light path switching device 102, and then they pass through a total internal reflection (TIR) prism set 104 and finally enter a projecting lens 106. Herein, although the TIR prism set 104 is functionally considered as being comprised of two parts, it is referred to as a unitary article for simplification.

Typically, on-axis projection is adapted for a projection system to provide adequate visibility of a projected pattern. In that case, light beams reflected from the micromirrors 102a must enter the projecting lens 106 in a direction parallel or substantially parallel to a non-reflected optical axis of the projecting lens 106. In order to meet such requirement, the incident light beams I, after being reflected by the TIR prism set 104, must maintain a predetermined tilt angle θ, namely an off-axis angle, with respect to the normal of the surface of the light path switching device 102 when they reach the micromirrors 102a. In other words, it is necessary to perform off-axis projection for the light path switching device 102 in any projection system incorporating the micromirrors 102a in order to achieve on-axis projection for the projecting lens 106.

FIG. 2A is a schematic view showing a conventional illumination system 110, wherein the light beams strike the light path switching device 102 at an off-axis angle θ. FIG. 2B is a schematic view showing an end surface of the light guide 114, a projection pattern formed through the off-axis projection, and a light-receiving section of the light path switching device 102.

It should be noted that, hereinafter, the term “end surface” of the light guide refers to only the light-transmitting portion of the light guide intercepted at one end of the light guide, and that the light-receiving section, formed from those micromirrors, is distributed over the entire surface of the light path switching device 102.

As shown in FIG. 2A, light beams emitting from a light source 112 are focused to the light guide 114 having interior reflecting walls where total internal reflection occurs repeatedly. Then, the light beams emit from one end of the light guide 114 as a uniform illumination and further strike the light path switching device 102 after passing through the relay lens 116.

However, a significant drawback is found in such an illumination system as the light beams strike the light path switching device 102 at an off-axis angle θ. Referring to FIG. 2B, when the light beams emitting from one end of the light guide 114 (A-A section) strike the light path switching device 102 at an off-axis angle θ, the projection pattern (dash line in B-B section) is subject to an elongation deformation, and thus its shape fails to match with the light-receiving section (hatched line in B-B section). Typically, the end surface of the light guide 114 is designed to have a rectangular shape in expectation of a rectangular projection pattern that matches with the rectangular light path switching device 102, as shown in FIG. 2B. However, the actual shape of the projection pattern is a parallelogram, with its two adjacent angles different from each other, rather than a rectangle due to the elongation deformation caused by the necessary off-axis projection. Hence, a large portion of the projected light beams are not received by the light path switching device 102, which considerably reduces the illumination efficiency.

### BRIEF SUMMARY OF THE INVENTION

An object of the invention is to provide an illumination system for a projector capable of ensuring that substantially all the incident light beams enter the light path switching device to enhance the illumination efficiency.

According to the invention, the illumination system includes a light guide and a light path switching device having a rectangular light-receiving section, and the light guide is disposed in the light path between the light source and the light path switching device. An end surface of the light guide has a parallelogrammic shape with its two adjacent interior angles different from each other.

Through the design of the invention, as the light beams emitting from the end surface strike the light path switching device to form a projection pattern on the light-receiving section, an elongation deformation due to the off-axis projection is offset by means of a modified shape of the end surface, and thus the projection pattern substantially coincides with the light-receiving section of the light path switching device. Hence, substantially all the light beams are received by the light path switching device, thus enhancing the illumination efficiency.

### BRIEF DESCRIPTION OF THE DRAWINGS

FIG. 1 is a schematic view of a conventional projection system including a light path switching device, where the light path for the light traveling under the “ON” state is shown.

FIG. 2A is a schematic view showing a conventional illumination system, wherein the light beams strike the light path switching device at an off-axis angle θ.

FIG. 2B is a schematic view showing an end surface of the light guide, a projection pattern formed through the off-axis projection, and a light-receiving section of the light path switching device.

FIG. 3 is a schematic view showing an illumination system for a projector according to an embodiment of the invention.

FIG. 4A is a schematic view showing an end surface of the conventional light guide and the projection pattern formed through the off-axis projection.

FIG. 4B is a schematic view showing an end surface of the light guide and the projection pattern formed through the off-axis projection according to the invention.

FIG. 5 is a schematic view showing an illumination system according to another embodiment of the invention.

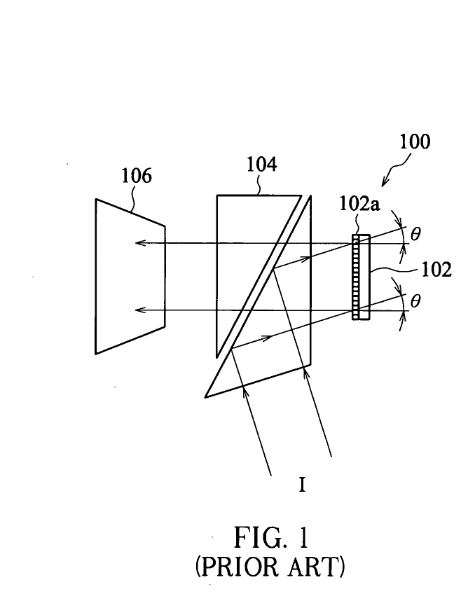

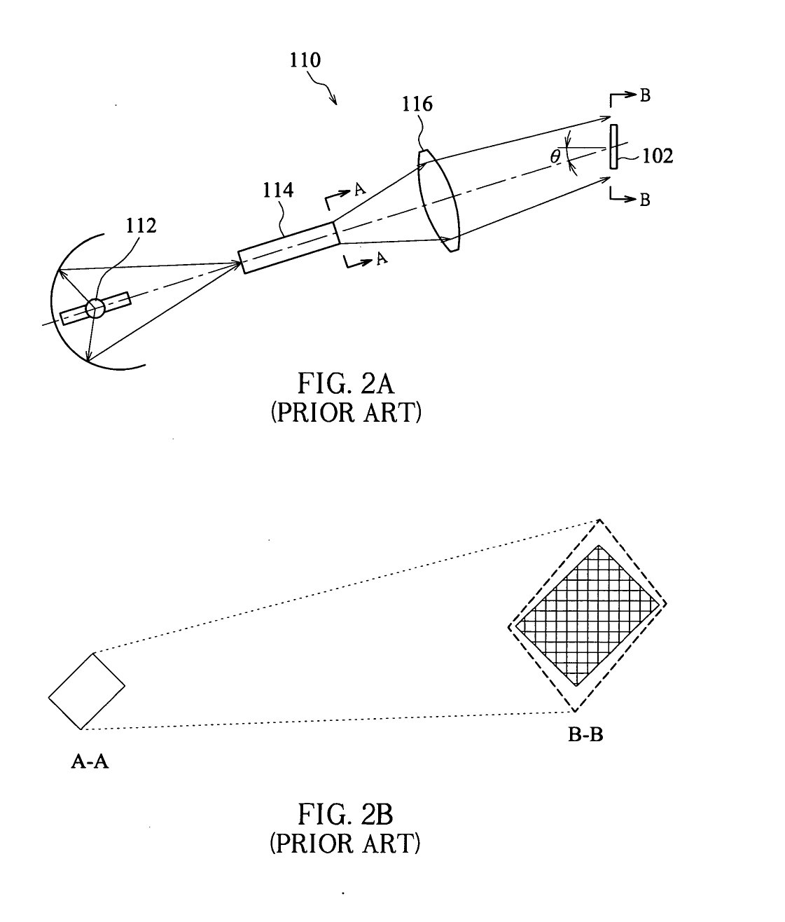

### DETAILED DESCRIPTION OF THE INVENTION

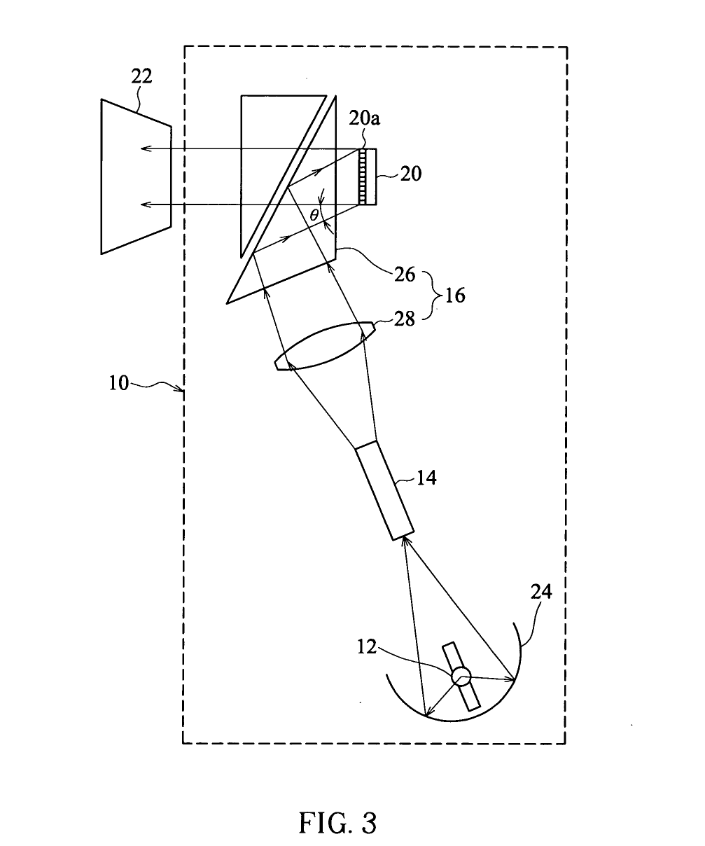

FIG. 3 is a schematic view showing an illumination system 10 for a projector according to an embodiment of the invention. Referring to FIG. 3, the illumination system 10 includes a light source 12, a light guide 14, a relay means 16, and a light path switching device 20 formed with a great number of light path switching elements 20a thereon.

A light collector such as an ellipsoidal reflector 24 may be arranged to partially surround the light source 12 in order to focus the light beams emitting from the light source 12 to the light guide 14. The relay means 16 is used for guiding the light beams from the light guide 14 to the light path switching device 20 along a specific route. For example, the relay means 16 may include an optical reflection component such as a total internal reflection (TIR) prism set 26 and a relay lens 28. The TIR prism set 26 typically consists of two sub prisms adhered to each other with an air gap interposed between them. The light beams from the light guide 14 are bent toward the light path switching device 20 by means of the TIR prism set 26 inside which total internal reflection occurs.

The light path switching device 20 includes a great number of light path switching elements 20a that are joined to form a light-receiving section on it. Each of the switching elements 20a is independently controlled to allow the incident light to further enter the projecting device 22 or not. The light path switching device 20 may be, for example, a digital micromirror device (DMD) or a reflective liquid crystal on silicon (LCOS). During operation, the light beams strike the light path switching elements 20a at a predetermined tilt angle, namely the aforesaid off-axis angle θ, with respect to the normal of the surface of the light path switching device 20.

The light guide 14, which is hollow with interior reflecting walls where total internal reflections successively occur, receives the light beams from the light source 12 and outputs them as evenly distributed light beams onto the light path switching elements 20a of the light path switching device 20 at the off-axis angle θ.

When the light beams emitting from an end surface of the light guide 14 form a projection pattern on the light path switching device 20, the actual projection pattern, compared to the expected one, is subject to an elongation deformation due to the necessary off-axis projection.

To solve such problems, a new design according to the invention is proposed. Briefly, the shape of the end surface of the light guide 14 is designed in a way to offset the elongation deformation of the projection pattern such that the projection pattern and the light-receiving section may have substantially the same shape and substantially coincide with each other.

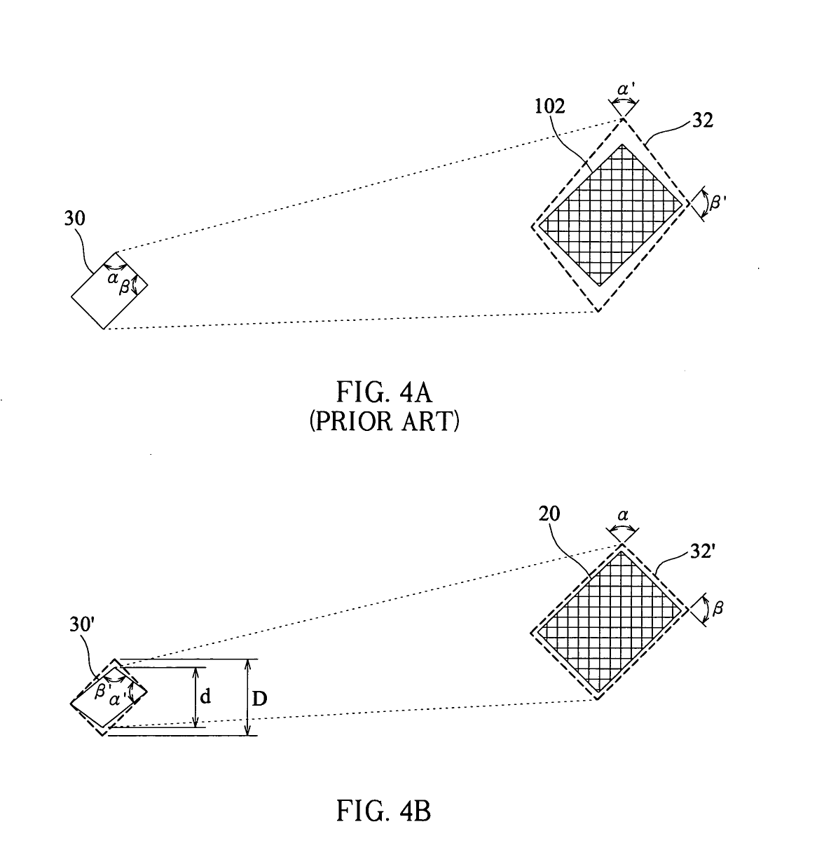

FIG. 4A and FIG. 4B are schematic diagrams showing the contrast between the conventional light guide 114 and the light guide 14 of the invention. In this embodiment, the off-axis angle θ is set at 24 degrees, and the light path switching elements that make up a light-receiving section with a rectangular shape are distributed over the entire surface of the light path switching devices 20 and 102, respectively.

Referring to FIG. 4A, the shape of the end surface 30 of the light guide 114 is a rectangle having interior angles α and β both equal to 90 degrees, and the projection pattern 32 formed on the light path switching devices 102 is subject to an elongation deformation due to the off-axis projection, such that the shape of the projection pattern 32 is a parallelogram having interior angle α′ equal to 88 degrees and adjacent interior angle β′ equal to 92 degrees. Therefore, the shape of the deformed projection pattern 32 fails to match with the rectangular light-receiving section of the light path switching device 102. As a result, a large portion of the light beams do not enter the light path switching device 102, thus reducing the illumination efficiency.

Referring to FIG. 4B, according to the invention, the end surface 30 of the light guide 114 is changed to the end surface 30′ of the light guide 14, which is obtained by substituting the interior angle α(=90°) with the interior angle β′(=92°) and β(=90°) with α′(=88°). That is, the shape of the end surface 30′ is specified as a parallelogram having two adjacent interior angles different from each other, and these interior angles are set with reference to the shape of the light-receiving section of the light path switching device 20. In other words, since the projection pattern 32 is elongated in a direction compared to the light-receiving section of the light path switching device 102, the end surface 30′ of the guide 14 is pre-modified in a reverse manner such that its dimension in the same direction is reduced from length D to length d; namely, the length of one diagonal line of the end surface 30′ is different from that of the other. As a result, the light beams emitting from the modified end surface 30′ can form a projection pattern 32′ that substantially coincides with the light path switching device 20, and they have substantially the same shape. Hence, substantially all the projected light beams are received by the light path switching device 20, thereby enhancing the illumination efficiency.

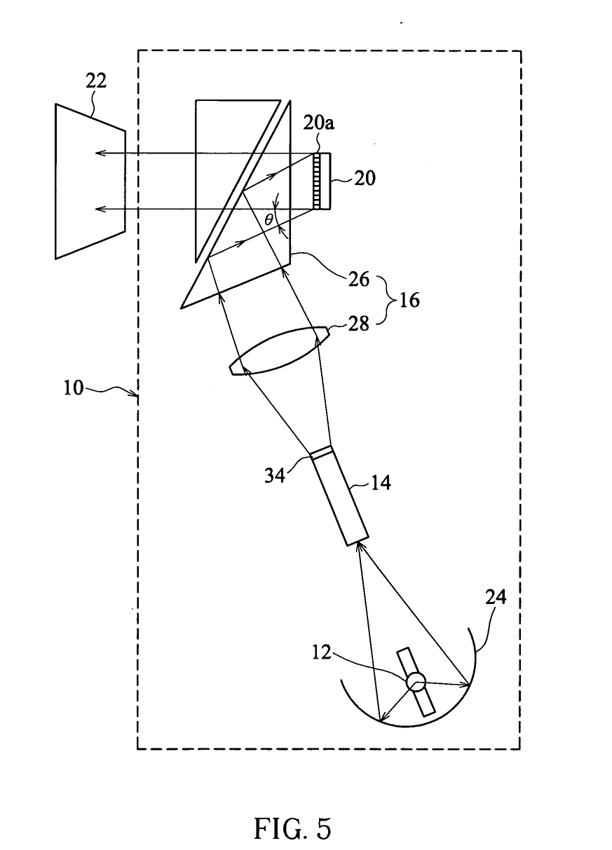

As shown in FIG. 5, after the light beams emit from the end surface of the light guide 14, they pass through the relay lens 28 and enter the TIR prism set 26, where total internal reflection occurs at an interface between the prism and an air gap. Then, the reflected light beams are incident on the light path switching device 20 in an off-axis manner. Through the design of the invention, since the end surface of the light guide is modified in advance, the elongation deformation of the projection pattern due to the off-axis projection can be eliminated almost entirely.

Also, since the elongation deformation of the projection pattern becomes more pronounced as the off-axis angle θ is increased, the illumination method according to the invention may further include a step of adjusting the angle of incidence of the light beams on the surface of the light switching device 20 to modify the shape of the projection pattern 32′.

Further, the way of modifying the end surface of the light guide is not restricted. For instance, the shape of the end surface can be specified during the manufacture of the light pipe, or alternatively, an additional shape correction element 34 may be affixed to the end surface, as shown in FIG. 5.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. An illumination system for a projector, comprising:
a light path switching device having a light-receiving section with a rectangular shape for receiving light beams emitting from a light source; and
a light guide disposed in the light path between the light source and the light path switching device,
wherein a projection pattern is formed by the light beams striking the light path switching device at an off-axis angle, and an end surface of the light guide has a parallelogrammic shape with its two adjacent interior angles different from each other such that the light-receiving section and the projection pattern have substantially the same shape and substantially coincide with each other.

2. The illumination system according to claim 1, further comprising at least one relay lens disposed in the light path between the light guide and the light path switching device.

3. The illumination system according to claim 1, further comprising an optical reflection component for directing the light beams from the light guide toward the light path switching device.

4. The illumination system according to claim 3, wherein the optical reflection component is a total internal reflection (TIR) prism set.

5. The illumination system according to claim 1, further comprising an ellipsoidal reflector surrounding the light source for focusing the light beams therefrom to the light guide.

6. The illumination system according to claim 1, wherein the light path switching device is a digital micromirror device (DMD) or a reflective liquid crystal on silicon (LCOS).

7. An illumination system for a projector, comprising:
a light path switching device having a light-receiving section with a rectangular shape for receiving light beams emitting from a light source; and
a light guide disposed in the light path between the light source and the light path switching device,
wherein a projection pattern is formed by the light beams striking the light path switching device at an off-axis angle, and an end surface of the light guide has a parallelogrammic shape with diagonal lines different in length from each another such that the light-receiving section and the projection pattern have substantially the same shape and substantially coincide with each other.

8. The illumination system according to claim 7, further comprising at least one relay lens disposed in the light path between the light guide and the light path switching device.

9. The illumination system according to claim 7, further comprising an optical reflection component for directing the light beams from the light guide toward the light path switching device.

10. The illumination system according to claim 9, wherein the optical reflection component is a TIR prism set.

11. The illumination system according to claim 7, further comprising an ellipsoidal reflector surrounding the light source for focusing the light beams therefrom to the light guide.

12. The illumination system according to claim 7, wherein the light path switching device is a digital micromirror device or a reflective liquid crystal on silicon.

13. An illumination method of an illumination system, comprising the steps of:
disposing a light guide in a light path between a light source and a light path switching device having a light-receiving section;
forming a projection pattern by guiding light beams emitting from the light source to pass through an end surface of the light guide and strike the light path switching device at an off-axis angle, the projection pattern being subject to an elongation deformation; and
modifying the shape of the end surface of the light guide to eliminate the elongation deformation.

14. The illumination method according to claim 13, wherein the light-receiving section has a rectangular shape, and the shape of the end surface is modified into a parallelogram with its two adjacent interior angles different from each other.

15. The illumination method according to claim 13, further comprising the step of modifying the shape of the projection pattern by adjusting the angle of incidence of the light beams on the surface of the light switching device.

16. The illumination method according to claim 13, wherein the shape of the end surface of the light guide is modified by affixing a shape correction element to the end of the light guide.
